(19) United States
(12) Patent Application Publication
(10) Pub. No.: US 2024/0020144 A1
(43) Pub. Date: Jan. 18, 2024

(54) OPTIMIZED DESKTOP INTERFACE PROVISIONING

(71) Applicant: VMware, Inc., Palo Alto, CA (US)

(72) Inventors: YiSan Zhao, Beijing (CN); Wen Wang, Beijing (CN); Nan Wang, Beijing (CN); Jingtao Zhang, Beijing (CN); Zhifu Jin, Beijing (CN); Xiangrui Meng, Beijing (CN)

(21) Appl. No.: 17/887,928

(22) Filed: Aug. 15, 2022

(30) Foreign Application Priority Data
Jul. 15, 2022 (WO) PCT/CN2022/105994

(51) Int. Cl. G06F 9/455

(52) U.S. Cl. CPC G06F 9/45558; G06F 2009/4557; G06F 2009/45595

(57) ABSTRACT

Systems and methods are described for provisioning a desktop interface at a cloud service provider. An application service is introduced that selects a cloud service provider for provisioning a virtual machine (“VM”) that hosts the desktop interface. In an example, a user can request access to a virtual desktop from a client device. The application service can retrieve network latency data from multiple cloud service providers and select the provider with the lowest network latency for the client device. In some examples, the application service can select the cloud service provider on additional factors, such as the cost of provisioning the VM at each cloud service provider. The application service can provision the VM at the selected cloud service provider and facilitate access to the virtual desktop for the client device.

### BACKGROUND

In the era of cloud computing, many applications or services are running in the cloud. Even desktop interfaces, such as those provided by Desktop as a Service (“DaaS”) platforms, can run in cloud computing environments. DaaS platforms allow users to use a desktop from any device and from any location with Internet access. DaaS providers have numerous provider options for deploying virtual desktops in the cloud. MICROSOFT AZURE, AMAZON WEB SERVICES, and GOOGLE CLOUD are just a few examples.

It can be difficult for DaaS providers to select the best cloud service provider for deploying a virtual desktop. Some important factors that can affect virtual desktop deployment can include network latency, cost, storage input/output (“I/O”), processing power, and so on. These factors can vary depending on the cloud service provider and the location of the user when accessing the virtual desktop. For example, the network latency from a cloud service provider may be acceptable at one location, but if the user travels to another location the network latency may rise to levels that negatively impact the user's experience. Currently, no method exists for determining whether switching cloud service providers at the other location may lower network latency for the user.

Also, when a virtual desktop is launched in one cloud service provider, there currently is no way to change provider. For example, if network latency suddenly spikes at one cloud service provider, there is no way to move the virtual desktops to another cloud service provider without rebuilding the DaaS services.

As a result, a need exists for improved provisioning of virtual desktops among cloud service providers.

### SUMMARY

Examples described herein include systems and methods for provisioning a desktop interface at a cloud service provider. As used herein, the terms “desktop interface” and “virtual desktop” are used interchangeably, and both terms refer to an implementation of a desktop metaphor made of a bundle of programs running on top of a computer operating system that share a common graphical user interface. A desktop metaphor can be a set of unifying concepts used by graphical user interfaces to help users interact more easily with the computer. An application service is introduced that manages the deployment of virtual desktops in a cloud computing environment, such as a DaaS platform. The application service, referred to throughout as the Smart Lifecycle Management (“SLCM”) service, can have multiple cloud service provider options for deploying the virtual desktop. The SLCM service can select one of the cloud service providers based on various factors.

In an example, a user can request access to a virtual desktop from a client device. The request can be sent to the SLCM service and the SLCM service can begin determining which cloud service provider to use for deploying the virtual desktop. In one example, the SLCM service can select a cloud service provider based on network latency measured at each cloud service provider. An SLCM agent can be installed at each cloud service provider that collects network latency data for the SLCM service. The SLCM agent can run on a virtual machine (“VM”) executing at each cloud service provider. In one example, the SLCM agent can continuously or periodically collect network latency data and send the network latency data to the SLCM service. Alternatively, the SLCM service, in response to the virtual desktop access request, can instruct the SLCM agent to measure the network latency between the cloud service provider and the client device. The SLCM service can determine which cloud service provider has the lowest network latency and provision a new VM for hosting the virtual desktop at that cloud service provider.

In some examples, other factors can be used in selecting a cloud service provider for deploying the virtual desktop. For example, the SLCM service can select a cloud service provider based on a combination of network latency and the cost of provisioning the VM at each cloud service provider. When a virtual desktop request is received from a client device, the SLCM service can retrieve network latency and provisioning cost data for each cloud service provider. In an example, the provisioning cost data can be provided by the cloud service providers. For example, the cloud service providers can include an Application Programming Interface (“API”) that clients can access to retrieve provisioning costs. The SLCM service can make an API call to the cloud service provider API to retrieve the provisioning cost data.

The SLCM service can determine a provisioning score for each cloud service provider. In an example, the provisioning scores can be based on assigned numerical values, or scores, corresponding to the network latency and provisioning costs. The SLCM service can weight the network latency scores and provisioning costs in relation to each other. For example, the SLCM service can use a multiplier, or add or subtract a predetermined number from the network latency or the provisioning cost.

After calculating the provisioning scores, the SLCM service can select the cloud service provider with the best score for deploying the virtual desktop. This can be the cloud service provider with the highest or lowest score, depending on how the provisioning scores are calculated. The SLCM service can then provision the VM at the selected cloud service provider. Provisioning the VM can include installing the required libraries and services for running the virtual desktop.

The examples summarized above can each be incorporated into a non-transitory, computer-readable medium having instructions that, when executed by a processor associated with a computing device, cause the processor to perform the stages described. Additionally, the example methods summarized above can each be implemented in a system including, for example, a memory storage and a computing device having a processor that executes instructions to carry out the stages described.

Both the foregoing general description and the following detailed description are exemplary and explanatory only and are not restrictive of the examples, as claimed.

### BRIEF DESCRIPTION OF THE DRAWINGS

FIG. 1 is a flowchart of an example method for provisioning a desktop interface at a cloud service provider.

FIG. 2 is a sequence diagram of an example method for provisioning a desktop interface at a cloud service provider.

FIG. 3 is another flowchart of an example method for provisioning a desktop interface at a cloud service provider.

FIG. 4 is another sequence diagram of an example method for provisioning a desktop interface at a cloud service provider.

FIG. 5 is an illustration of an example system for provisioning a desktop interface at a cloud service provider.

### DESCRIPTION OF THE EXAMPLES

Reference will now be made in detail to the present examples, including examples illustrated in the accompanying drawings. Wherever possible, the same reference numbers will be used throughout the drawings to refer to the same or like parts.

Systems and methods are described for provisioning a desktop interface at a cloud service provider. A desktop interface can be an implementation of a desktop metaphor made of a bundle of programs running on top of a computer operating system that share a common graphical user interface. A desktop metaphor can be a set of unifying concepts used by graphical user interfaces to help users interact more easily with the computer. An application service is introduced that selects a cloud service provider for provisioning a virtual machine (“VM”) that hosts the desktop interface. In an example, a user can request access to a virtual desktop from a client device. The application service can retrieve network latency data from multiple cloud service providers and select the provider with the lowest network latency for the client device. In some examples, the application service can select the cloud service provider on additional factors, such as the cost of provisioning the VM at each cloud service provider. The application service can provision the VM at the selected cloud service provider and facilitate access to the virtual desktop for the client device.

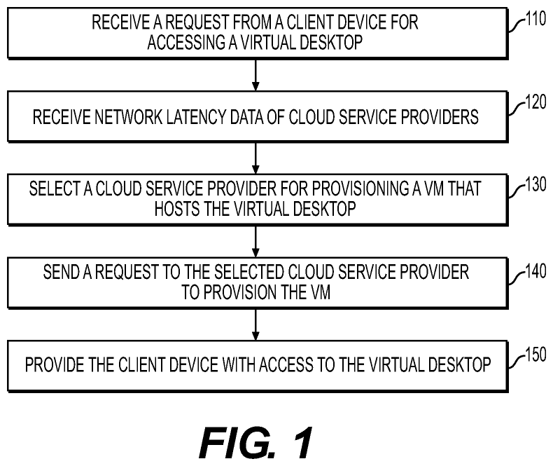

FIG. 1 is a flowchart of an example method for provisioning a desktop interface at a cloud service provider. At stage 110, an SLCM service can receive a request from a client device for accessing a virtual desktop. The client device can be one or more processor-based devices, such as a personal computer, tablet, or cell phone. The SLCM service can be an application service that manages the deployment of virtual desktops in a cloud computing environment, such as a DaaS platform, and can execute within the cloud computing environment or on a computing device outside of that environment, such as on a managed server or computer. Some examples of DaaS platforms include VMVVARE HORIZON CLOUD, CITRIX MANAGED DESKTOPS, and AMAZON WORKSPACES. The term “DaaS” is used herein to describe any virtual desktop deployment platform. Deploying a virtual desktop can include provisioning a virtual machine (“VM”) on a third-party cloud service provider, and the VM can launch the virtual desktop for use from a client device. Some examples of third-party cloud service providers can include MICROSOFT AZURE, AMAZON WEB SERVICES, and GOOGLE CLOUD.

The client device can send the virtual desktop access request based on user input. For example, the client device can display a frontend user interface of the DaaS. The frontend interface can be part of an application installed on the client device, or, alternatively, a web-based interface displayed in a web browser. Using the interface, a user can designate a virtual desktop and provide any required access credentials. Some examples of designating a virtual desktop can include selecting the virtual desktop from a list or providing the name or identifier (“ID”) of the virtual desktop. In one example, the user can log in to the DaaS with access credentials, such as a username and password or a one-time password (“OTP”), and the interface can display a list of virtual desktops available to the user.

In the examples described herein, the DaaS can have the option to provision the VM on one of multiple available cloud service providers. In response to a user requesting a virtual desktop, the SLCM service can determine the best cloud service provider to use for deploying the virtual desktop. This can be based at least in part on a determination of how much network latency the user will experience if the virtual desktop were deployed from each of available cloud service providers. To make this determination, at stage 120, the SLCM service can receive network latency data of cloud service providers. In an example, the SLCM service can include a network latency detection (“NLD”) engine that is responsible for obtaining and analyzing network latency data. The NLD engine can instruct an SLCM agent running on each of the cloud service providers to gather the network latency data and report it back to the NLD engine. The network latency data can include data relating to network latency, throughput, and packet transmission. The SLCM agent can run on a pre-provisioned VM deployed on each of the cloud service providers. The SLCM agent can perform network tests and send the results to the NLD engine. Some examples of such tests can include pinging the client device, a traceroute, a One-Way Active Measurement Protocol (“OWAMP”) test, a Two-Way Active Measurement Protocol (“TWAMP”) test, or an Iperf test. In one example, the NLD engine can retrieve network latency data from the SLCM agents running on each cloud service provider in response to a virtual desktop request. This can provide the NLD engine with the most up-to-date network latency data.

In some examples, the SLCM agents can run a network latency test with the client device in response to the virtual desktop request. This can provide a more accurate prediction of the network latency the user would experience with each of the cloud service providers. In such an example, the NLD engine can send network information of the client device to the SLCM agents, such as an internet protocol (“IP”) address and media access control (“MAC”) address. The SLCM agents can then perform network tests directly with the client device and report the results to the NLD engine, such as by performing one or more of the network tests described previously above.

Cloud service providers can have cloud servicing datacenters at various geographic locations. The distance between the client device and the datacenter can impact network latency. For at least this reason, the NLD engine can obtain network latency data from SLMC agents hosted at datacenters located in the same or the closest geographic region of the client device when the virtual desktop request is made. There are various ways that the NLD engine can determine the client device's location. In one example, the client device can provide location data, such as a global positioning system (“GPS”) location. In other example, the NLD engine can determine the location based on network information, such as the location of network that the client device is connected to when making the request or the location of a network server that handles the request.

At stage 130, the SLCM service can select, based on the network latency data, a cloud service provider for provisioning a VM that hosts the virtual desktop. In one example, the SLCM can select the cloud service provider with the lowest measured network latency. The selection can sometimes depend on available resources at the cloud service providers. As an example, the DaaS can have an allotted number of VMs that can be simultaneously hosted at each cloud service provider. The allotments can be according to geographic region as well. If the VM allotment is full at the cloud service provider with the lowest network latency, then the SLCM service can select the cloud service provider with the second lowest network latency.

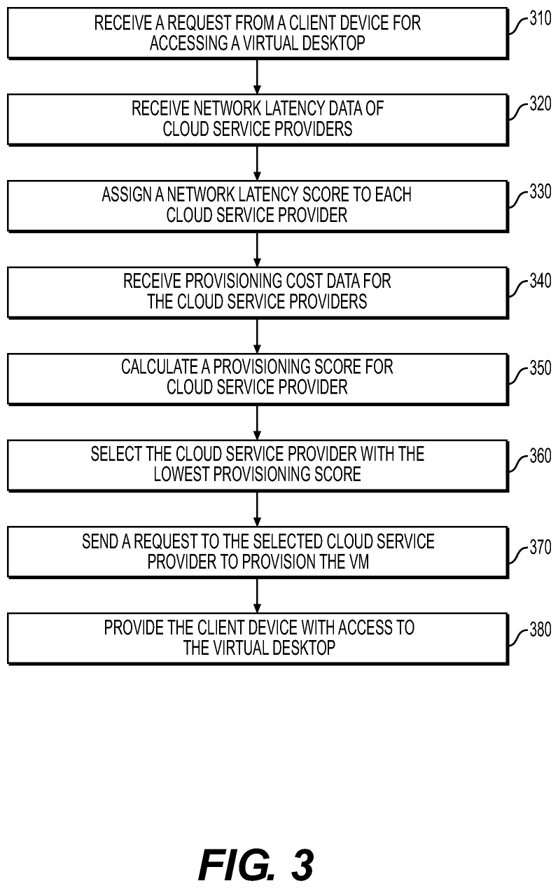

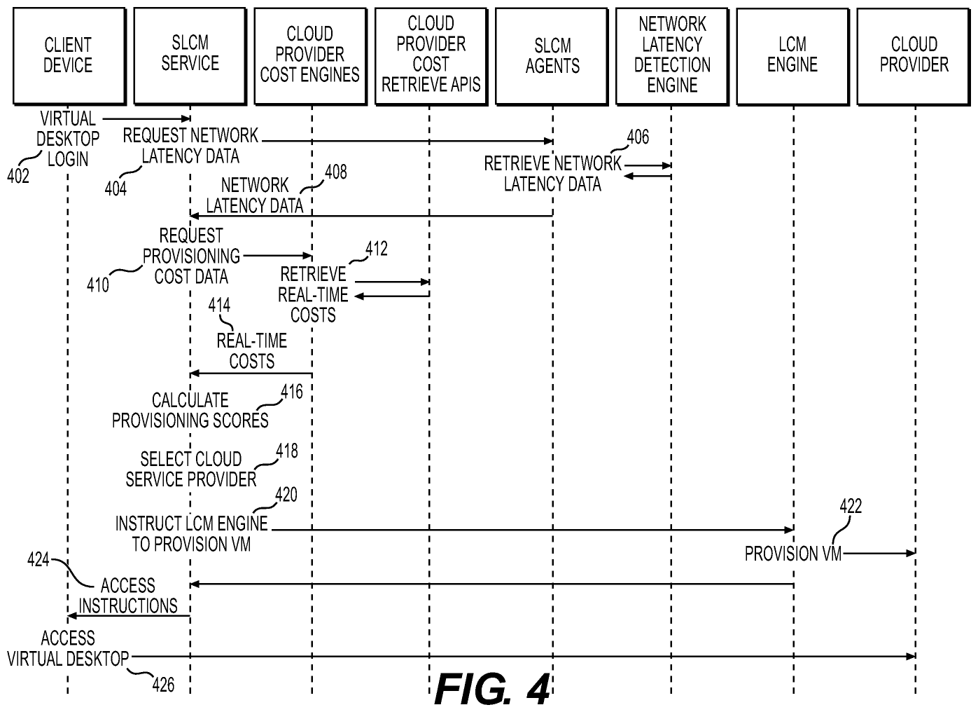

Other factors can be used for selecting the cloud service provider. For example, the SLCM service can compare the network latency to a predetermined threshold, and any cloud service provider with a measured network latency below the threshold can be considered to have negligible network latency. As an example, if a threshold network latency is 50 ms, then any cloud service provider with a measured network latency below 50 ms can be treated as equally having the lowest network latency, and other factors can be used for the selection. In one example, the SLCM service can select the cloud service provider with the highest number of available VM hosting slots for the DaaS. In another example, the DaaS can have a preferred cloud service provider, and the preferred provider is selected whenever its measured network latency is below the threshold. In another example, the SLCM service can select the cloud service provider with the lowest running cost. Examples of cloud service provider selections that include running cost factors are described in detail later herein regarding FIGS. 3 and 4.

At stage 140, the SLCM service can send a request to the selected cloud service provider to provision the VM. In one example, the SLCM can include a lifecycle management (“LCM”) engine that is responsible for provisioning and decommissioning VMs at the cloud service providers. After a cloud service provider is selected, the LCM engine can provision the VM on the selected cloud service provider. Provisioning the VM can include installing the required libraries and services for running the virtual desktop.

At stage 150, the SLCM service can provide the client device with access to the virtual desktop. In one example, the LCM engine can log the user into the VM using the access credentials previously provided. Alternatively, the LCM engine can provide the client device with an OTP or other single-use credential that the client device can present to the VM to gain access. The client device can then communicate with the VM to provide the virtual desktop to the user. For example, the client device can send user inputs to the VM, and the VM can execute the user inputs at the virtual desktop. The VM can update the display of the virtual desktop at the client device based on the user inputs.

In some examples of the above-described method, the SLCM service can dynamically migrate cloud service providers for a deployed virtual desktop. For example, the SLCM agent can collect network latency data for deployed virtual desktops at the selected cloud service provider. If the network latency exceeds a threshold, then the SLCM service can migrate the virtual desktop to an alternative cloud service provider. For example, the SLCM service can analyze network latency data at other cloud service providers. If another cloud service provider has a lower network latency, such as a network latency below the threshold, then the SLCM service can provision a new VM at the other cloud service provider. This can include retrieving information about the state of the virtual desktop deployed on the original cloud service provider. The SLCM service can send this information to the new cloud service provider so that the virtual desktop can be deployed in the same state. When the new VM is provisioned and running the virtual desktop, the SLCM service can send instructions to the client device for migrating to the other cloud service provider. In one example, if the migration causes any pause in the user's ability to access the virtual desktop, the client device can display a message informing the user that the virtual desktop is being migrated to improve the network latency.

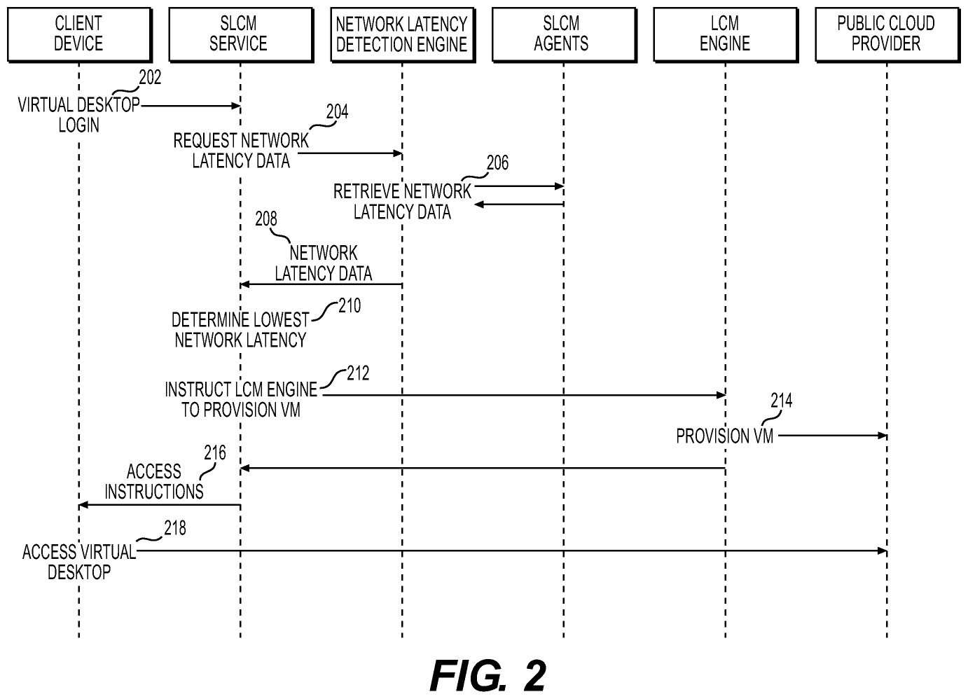

FIG. 2 is a sequence diagram of an example of method described above regarding FIG. 1. At stage 202, a user can provide login information for the virtual desktop at the client device. For example, the client device can display a frontend user interface of a DaaS. The user can input login information into the frontend interface, including identifying the virtual desktop that the user wants to access. In one example, the user can first log in to the DaaS, and then the frontend interface can display the virtual desktops available to the user. Alternatively, the user can specify the virtual desktop when providing the credentials.

At stage 204, the SLCM service can request network latency data from the NLD engine. In one example, the request can be instructions. For example, the SLCM service can instruct the NLD to obtain network latency data of the available cloud service providers. In one example, the instructions can indicate a geographic location or region for obtaining the network latency data. For example, the SLCM service can instruct the NLD engine to obtain network latency data from SLMC agents hosted at datacenters located in the same or the closest geographic region of the client device when the virtual desktop request is made. In some examples, the SLCM service can instruct SLMC agents hosted on datacenters to obtain network latency data from multiple geographic regions of a cloud service provider, so that the latency data can be compared across different regions. This can be performed across multiple cloud service providers as well.

At stage 206, the NLD engine can retrieve network latency data from SLCM agents running at the cloud service providers. In one example, the SLCM agents can continuously or periodically measure network latency at their respective cloud service providers. The SLCM agents can send the network latency data to the NLD engine as it is generated. Alternatively, the SLCM agents can send the network latency data in response to a request from the NLD engine.

In some examples, the SLCM agents can run a network latency test with the client device. This can provide a more accurate prediction of the network latency the user would experience with each of the cloud service providers. In such an example, the NLD engine can send network information of the client device to the SLCM agents, such as the client device's IP address and media access control MAC address. The SLCM agents can then perform network tests directly with the client device and report the results to the NLD engine. For example, the SLCM agent can ping the client device, perform a traceroute, perform a OWAMP test, perform a TWAMP test, or perform an Iperf test.

At stage 208, the NLD engine can send the network latency data to the SLCM service. Sending the network latency data can include making the network latency data available to the SLCM service. For example, the NLD engine can store the network latency data to a cache that the SLCM service can access. The SLCM service can be notified when the data is available. In one example, the NLD service can notify the SLCM service. Alternatively, the NLD engine can create an event log for saving the network latency data, and the SLC service can detect when such an event log is created by the NLD service.

At stage 210, the SLCM service can determine which cloud service provider has the lowest network latency. For example, the SLCM service can compare the measured network latency of each cloud service provider and identify the cloud service provider with the lowest network latency. In one example, the SLCM service can compare the network latencies to a threshold, and any cloud service provider with a measured network latency below the threshold can be considered to have negligible network latency. If multiple cloud service providers have a measured network latency below the threshold, then other factors can be used for selecting a cloud service provider to host the VM. For example, the SLCM service can select a cloud service provider based on a preferred cloud service provider, the number of available VM hosting slots, and so on.

At stage 212, the SLCM service can instruct the LCM engine to provision the VM at the cloud service provider with the lowest network latency. The instructions can identify the cloud service provider and the virtual desktop to be hosted by the VM. At stage 214, the LCM engine can provision the VM at the cloud service provider. Provisioning the VM can include installing the required libraries and services for running the virtual desktop. In some examples, provisioning the VM can include installing a virtual disk image to the VM. The virtual disk image can include all required files and settings for the VM.

At stage 216, the SLCM engine can provide the client device with access to the virtual desktop. In one example, the LCM engine can log the user into the VM using the access credentials previously provided. Alternatively, the LCM engine can provide the client device with an OTP or other single-use credential that the client device can present to the VM to gain access.

At stage 218, the client device can access the virtual desktop. For example, the VM can send display information for the virtual desktop to the client device. The client device can send user inputs to the VM, and the VM can execute the user inputs at the virtual desktop. The VM can then update the display of the virtual desktop at the client device based on the user inputs.

FIG. 3 is another flowchart of an example method for provisioning a desktop interface at a cloud service provider based on network latency and running costs of multiple available cloud service providers. At stage 310, the SLCM service can receive a request from a client device for accessing a virtual desktop. The client device can send the virtual desktop access request based on user input. For example, the client device can display a frontend user interface of the DaaS. The frontend interface can be part of an application installed on the client device, or, alternatively, a web-based interface displayed in a web browser. Using the interface, a user can designate a virtual desktop and provide any required access credentials. Some examples of designating a virtual desktop can include selecting the virtual desktop from a list or providing the name or ID of the virtual desktop. In one example, the user can log in to the DaaS with access credentials, such as a username and password or an OTP, and the interface can display a list of virtual desktops available to the user.

At stage 320, the SLCM service can receive network latency data of available cloud service providers. In an example, the SLCM service can include an NLD engine that is responsible for obtaining and analyzing network latency data. The NLD engine can instruct an SLCM agent running on each of the cloud service providers to gather the network latency data and report it back to the NLD engine. The SLCM agent can run on a pre-provisioned VM deployed on each of the cloud service providers. The SLCM agent can perform network tests and send the results to the NLD engine. Some examples of such tests can include pinging the client device, a traceroute, a OWAMP test, a TWAMP test, or an Iperf test. In one example, the NLD engine can retrieve network latency data from the SLCM agents running on each cloud service provider in response to a virtual desktop request. This can provide the NLD engine with the most up-to-date network latency data.

In some examples, the SLCM agents can run a network latency test with the client device in response to the virtual desktop request. This can provide a more accurate prediction of the network latency the user would experience with each of the cloud service providers. In such an example, the NLD engine can send network information of the client device to the SLCM agents, such as an IP address and MAC address. The SLCM agents can then perform network tests directly with the client device and report the results to the NLD engine, such as by performing one or more of the network tests described previously above.

Cloud service providers can have cloud servicing datacenters at various geographic locations. The distance between the client device and the datacenter can impact network latency. For at least this reason, the NLD engine can obtain network latency data from SLMC agents hosted at datacenters located in the same or the closest geographic region of the client device when the virtual desktop request is made. There are various ways that the NLD engine can determine the client device's location. In one example, the client device can provide location data, such as a GPS location. In other example, the NLD engine can determine the location based on network information, such as the location of network that the client device is connected to when making the request or the location of a network server that handles the request. In some examples, the SLCM service can instruct SLMC agents hosted on datacenters to obtain network latency data from multiple geographic regions of a cloud service provider, so that the latency data can be compared across different regions. This can be performed across multiple cloud service providers as well.

At stage 330, the SLCM service can assign a network latency score to each cloud service provider based on the network latency data. The network latency scores can be assigned using any method. In one example, the SLCM service can assign network latency scores based on network latency ranges. For example, if the network latency is greater than or equal to 10 ms and less than 11 ms, then the assigned score can be 10. In another example, the SLCM service can assign network latency scores based on a rounded network latency measurement. For example, a 7.459 ms latency can be assigned a score of 7.5 or 7.46. In one example, the SLCM service can assign the same score to any latency measurement under a predetermined threshold. The predetermined threshold can be set by the SLCM service or an admin. For example, an admin can determine that any latency under 20 ms will not negatively affect the user's experience, so the admin can set a 20 ms threshold. Any cloud service provider with a measured latency under 20 ms would be assigned the same network latency score. In some examples, the network latency score is a scale representing best to worst, such as a 0-10 scale where 10 is the best latency (such as below 20 ms) and 0 is the worst latency (no connection or latency above an upper threshold).

At stage 340, the SLCM service can receive provisioning cost data for the cloud service providers. In an example, the SLCM service can include a cloud service provider cost (“CSPC”) engine that is responsible for obtaining and analyzing provisioning cost data. The CSPC engine can retrieve the provisioning cost data from a cloud provider cost retrieve (“CPCR”) API. The CPCR API can be an API provided by the cloud service providers that provides up-to-date pricing on various different types of VMs offered by each cloud service provider. The CSPC engine can make an API call to the CPCR API to retrieve the provisioning cost data. In an example, the CSPC can make the API call in response to the virtual desktop request so that the provisioning cost data is provided in real-time. In another example, the CSPC can make periodic API calls and maintain a table with costs that are updated based on the periodic calls.

At stage 350, the SLCM service can calculate a provisioning score for each cloud service provider. The provisioning scores can be calculated using any method. In one example, the SLCM service can determine a cost per time unit for each cloud service provider. For example, the SLCM service can determine a cost per hour for provisioning the VM at each cloud service provider. The SLCM service can then multiply the network latency score and the cost per time unit, resulting in the provisioning score. As an example, if the network latency score is 3.45 and the cost per hour is $0.0974, then the SLCM service can calculate the provisioning score for the cloud service provider by multiplying 3.45 by 0.0974 to get a provisioning score of 0.336.

Some cloud service providers provide options for different types of VM provisioning. For example, some cloud service providers provide general purpose, compute optimized, memory optimized, and accelerated computing provisioning. General purpose provisioning can correspond to a standard VM provisioning type. Compute optimized can provide additional processing power. Memory optimized can provide additional memory space. Accelerated computing can provide hardware accelerators, or co-processors, to perform certain functions. The cloud service providers can provide different rates for each provisioning type. In some examples, the requested virtual desktop can have a pre-assigned provisioning type, and the cost for the pre-assigned provisioning type can be used in calculating the provisioning score. In other examples, the user can select a provisioning type, and the cost of the selected provisioning type can be used in calculating the provisioning score.

In an example, the SLCM service can weight the network latency scores and provisioning costs. For example, if the enterprise wants network latency to be a bigger or smaller factor in the provisioning score, then the SLCM service can do this by weighting the network latency score, for example. Some ways of weighting the network latency score can include using a multiplier, or adding or subtracting a predetermined number to the network latency. Any scoring weights can be determined by an admin. For example, the admin can access a graphical user interface with mechanisms for modifying scoring weights, such as a sliders, drop-down menus, or input fields.

At stage 360, the SLCM service can select the cloud service provider with the lowest provisioning score. For example, the methods for assigning network latency scores and calculating provisioning scores described above result in the lowest provisioning score being the best option because lower latency receives a lower network latency score and lower provisioning costs receive lower cost multipliers. The predetermined network latency threshold described previously can be used to select the cheapest cloud service provider with acceptable network latency. For example, if acceptable latency includes anything below 50 ms, then all cloud service providers with a measured network latency below 50 ms will receive the same network latency score. The running costs would then determine which of these cloud service providers has the lowest provisioning score.

Although this method describes selecting the cloud service provider with the lowest provisioning score, this is not meant to be limiting in any way. For example, some methods of assigning network latency scores and calculating provisioning scores can cause the highest provisioning score to indicate the best option. For such methods, the SLCM service can select the cloud service provider with the highest scoring provisioning score.

At stage 370, the SLCM service can send a request to the selected cloud service provider to provision the VM that hosts the virtual desktop. In one example, the SLCM can include an LCM engine that is responsible for provisioning and decommissioning VMs at the cloud service providers. After a cloud service provider is selected, the LCM engine can provision the VM on the selected cloud service provider. Provisioning the VM can include installing the required libraries and services for running the virtual desktop.

At stage 380, the SLCM service can provide the client device with access to the virtual desktop. In one example, the LCM engine can log the user into the VM using the access credentials previously provided. Alternatively, the LCM engine can provide the client device with an OTP or other single-use credential that the client device can present to the VM to gain access. The client device can then communicate with the VM to provide the virtual desktop to the user. For example, the client device can send user inputs to the VM, and the VM can execute the user inputs at the virtual desktop. The VM can update the display of the virtual desktop at the client device based on the user inputs.

In some examples of the above-described method, the SLCM service can dynamically migrate cloud service providers for a deployed virtual desktop. For example, the SLCM agent can collect network latency data for deployed virtual desktops at the selected cloud service provider. If the network latency exceeds a threshold, then the SLCM service can migrate the virtual desktop to an alternative cloud service provider. For example, the SLCM service can retrieve updated network latency data and provisioning cost data, calculate new provisioning scores for each cloud service provider, and select an alternative cloud service provider. The SLCM service can then provision a new VM at the new cloud service provider. This can include retrieving information about the state of the virtual desktop deployed on the original cloud service provider. The SLCM service can send this information to the new cloud service provider so that the virtual desktop can be deployed in the same state. When the new VM is provisioned and running the virtual desktop, the SLCM service can send instructions to the client device for migrating to the other cloud service provider. In one example, if the migration causes any pause in the user's ability to access the virtual desktop, the client device can display a message informing the user that the virtual desktop is being migrated to improve the network latency.

FIG. 4 is a sequence diagram of an example of method described above regarding FIG. 3. At stage 402, a user can provide login information for the virtual desktop at the client device. For example, the client device can display a frontend user interface of a DaaS. The user can input login information into the frontend interface, including identifying the virtual desktop that the user wants to access. In one example, the user can first log in to the DaaS, and then the frontend interface can display the virtual desktops available to the user. Alternatively, the user can specify the virtual desktop when providing the credentials.

At stage 404, the SLCM service can request network latency data from the NLD engine. In one example, the request can be instructions. For example, the SLCM service can instruct the NLD to obtain network latency data of the available cloud service providers. In one example, the instructions can indicate a geographic location or region for obtaining the network latency data. For example, the SLCM service can instruct the NLD engine to obtain network latency data from SLMC agents hosted at datacenters located in the same or the closest geographic region of the client device when the virtual desktop request is made. In some examples, the SLCM service can instruct SLMC agents hosted on datacenters to obtain network latency data from multiple geographic regions of a cloud service provider, so that the latency data can be compared across different regions. This can be performed across multiple cloud service providers as well.

At stage 406, the NLD engine can retrieve network latency data from SLCM agents running at the cloud service providers. In one example, the SLCM agents can continuously or periodically measure network latency at their respective cloud service providers. The SLCM agents can send the network latency data to the NLD engine as it is generated. Alternatively, the SLCM agents can send the network latency data in response to a request from the NLD engine.

In some examples, the SLCM agents can run a network latency test with the client device. This can provide a more accurate prediction of the network latency the user would experience with each of the cloud service providers. In such an example, the NLD engine can send network information of the client device to the SLCM agents, such as the client device's IP address and media access control MAC address. The SLCM agents can then perform network tests directly with the client device and report the results to the NLD engine. For example, the SLCM agent can ping the client device, perform a traceroute, perform a OWAMP test, perform a TWAMP test, or perform an Iperf test.

At stage 408, the NLD engine can send the network latency data to the SLCM service. Sending the network latency data can include making the network latency data available to the SLCM service. For example, the NLD engine can store the network latency data to a cache that the SLCM service can access. The SLCM service can be notified when the data is available. In one example, the NLD service can notify the SLCM service. Alternatively, the NLD engine can create an event log for saving the network latency data, and the SLC service can detect when such an event log is created by the NLD service.

At stage 410, the SLCM engine can request provisioning cost data from the CSPC engine. In one example, the request can be instructions. For example, the SLCM service can instruct the CSPC engine to obtain provisioning cost data from the available cloud service providers. In one example, the instructions can indicate a geographic location or region for obtaining the provisioning cost data. For example, if a cloud service provider charges different rates based on geographic region, then the SLCM service can request provisioning cost data for the cloud service provider in the region where the user is accessing the virtual desktop.

At stage 412, the CSPC engine can retrieve the provisioning cost data from CPCR APIs of the cloud service providers. For example, the CSPC engine can make an API call to the cloud service providers, and the cloud service providers can respond with a data file that includes provisioning cost data. The data file can be in any format that can include cost data, such as a JavaScript Object Notation (“JSON”) file. In an example, the CSPC can make the API call in response to the virtual desktop request so that the provisioning cost data is provided in real-time. In another example, the CSPC can make periodic API calls and maintain a table with costs that are updated based on the periodic calls.

At stage 414, the CSPC engine can send the provisioning cost data to the SLCM engine. Sending the provisioning cost data can include making the provisioning cost data available to the SLCM service. For example, the CSPC engine can store the provisioning cost data to a cache that the SLCM service can access. The SLCM service can be notified when the provisioning cost data is available. In one example, the CSPC service can notify the SLCM service. Alternatively, the CSPC engine can create an event log for saving the provisioning cost data, and the SLCM service can be subscribed to the event log type.

At stage 416, the SLCM engine can calculate provisioning scores for each of the cloud service providers. The provisioning scores can be based on the network latency data and the provisioning cost data. For example, the SLCM engine can assign one value to each cloud service provider corresponding to the network latency and another value based on the provisioning costs. The network latency value can correspond to the network latency score described previously herein. The SLCM engine can combine the network latency score and assigned provisioning cost value to create a provisioning score. The SLCM engine can use any calculation or algorithm that generates a provisioning score. In one example, the SLCM engine can simply multiply the two values together. In another example, the SLCM can add weights to each value, or use an algorithm that weights the network latency higher or lower with respect to the provisioning costs. Additional methods for calculating provisioning scores are described previously herein regarding stage 350 of FIG. 3.

At stage 418, the SLCM service can select a cloud service provider based on the provisioning scores. For example, where a lower score indicates a better option, then the SLCM service can select the cloud service provider with the lowest score. On the other hand, where a higher score indicates a better option, then the SLCM service can select the cloud service provider with the highest score.

At stage 420, the SLCM service can instruct the LCM engine to provision the VM at the selected cloud service provider. The instructions can identify the cloud service provider and the virtual desktop to be hosted by the VM. At stage 422, the LCM engine can provision the VM at the cloud service provider. Provisioning the VM can include installing the required libraries and services for running the virtual desktop. In some examples, provisioning the VM can include installing a virtual disk image to the VM. The virtual disk image can include all required files and settings for the VM.

At stage 424, the SLCM engine can send the VM access data to the client device. In one example, the LCM engine can log the user into the VM using the access credentials previously provided. Alternatively, the LCM engine can provide the client device with an OTP or other single-use credential that the client device can present to the VM to gain access.

At stage 426, the client device can access the virtual desktop at the selected cloud service provider. For example, the VM can send display information for the virtual desktop to the client device. The client device can send user inputs to the VM, and the VM can execute the user inputs at the virtual desktop. The VM can then update the display of the virtual desktop at the client device based on the user inputs.

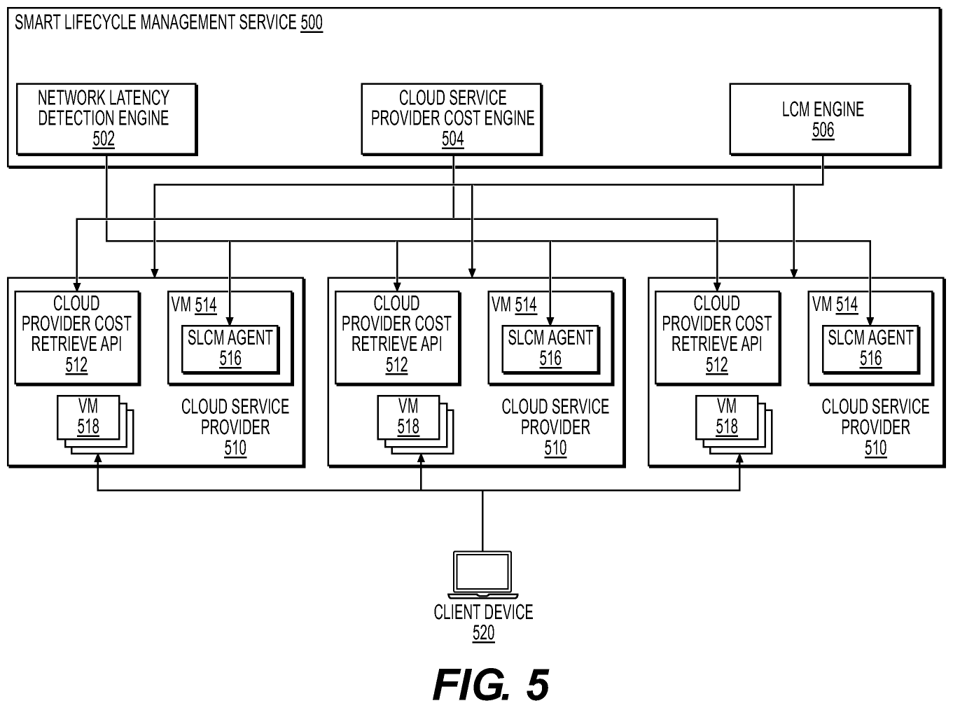

FIG. 5 is an illustration of an example system for provisioning a desktop interface at a cloud service provider. An SLCM service 500 can help manage the deployment of virtual desktops in a cloud computing environment. For example, the SLCM service can be an application service running on a server, such as a server or VM of a DaaS platform. The SLCM service 500 can include various engines that perform specific functions, such as an NLD engine 502, a CSPC engine 504, and an LVM engine 506. The NLD engine 502, CSPC engine 504, and LVM engine 506 can be processes, or sets of processes, executing on a server. In one example, the SLCM service 500, NLD engine 502, CSPC engine 504, and LVM engine 506 can all run on the same server or VM. Alternatively, they can run on separate servers or VMs.

The NLD engine 502 can be responsible for obtaining and analyzing network latency data. The NLD engine 502 can communicate with a SLCM agent 516 executing on a pre-provisioned VM 514 on each cloud service provider 510 that is available for deploying the virtual desktop. In some examples, a cloud service provider 510 maintains a pool of available VMs, such as five or ten free VMs. The pre-provisioned VM 514 can be one of these available VMs, for example.

The cloud service providers 510 can be third-party entities that provider cloud computing services, such as MICROSOFT AZURE, AMAZON WEB SERVICES, and GOOGLE CLOUD. The SLCM agent 516 at each cloud service provider 510 can run network tests and send the results to the NLD engine 502. The SLCM agent 516 can send the network latency results to the NLD engine 502 using any communication protocol, such as an API call.

The CSPC engine 504 can be responsible for obtaining and analyzing provisioning cost data from the cloud service providers 510. The provisioning cost data can be provided by the cloud service providers 510 and include the cost for provisioning and running a VM. The CSPC engine 504 can retrieve the provisioning cost data from a CPCR API 512 at the cloud service providers 510. The CSPC engine 504 can make an API call to the CPCR API 512 requesting the provisioning cost data, and the CPCR API 512 can respond with the data. In an example, the CPCR API 512 can send the provisioning cost data as a data file, such as a JSON file.

The SLCM service 500 can select a cloud service provider 510 for provisioning a VM 518 when a user requests access to a virtual desktop. The SLCM service 500 can select a cloud service provider 510 based on the network latency data and the provisioning cost data. This can be done, for example, using the example methods described previously herein. The LCM engine 506 can be responsible for deploying VMs 518 at the cloud service providers 510. After selecting a cloud service provider 510 for deploying the virtual desktop, the LCM engine 506 can provision a VM 518 at the selected cloud service provider 510. Provisioning a VM 518 can include installing the required libraries and services for running the virtual desktop on the VM 518.

After the VM 518 has been provisioned, the SLCM service 500 can provide access to a client device 520. The client device 520 can be one or more processor-based devices, such as a personal computer, tablet, or cell phone. For example, the SLCM service 500 can log the user into the virtual desktop using credentials provided at the client device 520. The SLCM service 500 can also facilitate connecting the client device 520 to the VM 518, such as by providing network information for connecting to the VM 518. The user can then access the virtual desktop through the client device 520.

Other examples of the disclosure will be apparent to those skilled in the art from consideration of the specification and practice of the examples disclosed herein. Though some of the described methods have been presented as a series of steps, it should be appreciated that one or more steps can occur simultaneously, in an overlapping fashion, or in a different order. The order of steps presented are only illustrative of the possibilities and those steps can be executed or performed in any suitable fashion. Moreover, the various features of the examples described here are not mutually exclusive. Rather any feature of any example described here can be incorporated into any other suitable example. It is intended that the specification and examples be considered as exemplary only, with a true scope and spirit of the disclosure being indicated by the following claims.

What is claimed is:

1. A method for provisioning a desktop interface at a cloud service provider, comprising:
receiving a request for access to a desktop interface at a client device;
retrieving network latency data related to a plurality of cloud service providers;
selecting, based on the network latency data, a cloud service provider from the plurality for provisioning a virtual machine (“VM”) that hosts the desktop interface;
sending, to the selected cloud service provider, a request to provision the VM; and
sending, to the client device, instructions for accessing the VM.

2. The method of claim 1, wherein retrieving the network latency data is performed by a plurality of VMs, each of the plurality of VMs executing at one of the plurality of cloud service providers, respectively, wherein each of the plurality of VMs executes an agent that tests the network latency between the respective VM and the client device.

3. The method of claim 1, further comprising receiving provisioning cost data for each of the plurality of cloud service providers, the provisioning cost data indicating a cost for provisioning the VM on the corresponding cloud service provider, wherein selecting the selected cloud service provider comprises:
assigning a network latency score to each of the plurality of cloud service providers;
applying a provisioning cost multiplier to the network latency score for each of the plurality of cloud service providers, the provisioning cost multiplier being based on the cost for provisioning the VM on the corresponding cloud service provider;
calculating, for each of the plurality of cloud service providers, a provisioning score, the provisioning score being based on the cloud service provider's network latency score and provisioning cost multiplier; and
selecting, based on the provisioning scores, the selected cloud service provider based on the selected cloud service provider having a lowest provisioning score.

4. The method of claim 3, wherein each cloud service provider with a network latency below a threshold is assigned a same network latency score.

5. The method of claim 3, further comprising determining a geographic location of the client device, wherein the network latency data and provisioning cost data are based on the geographic location.

6. The method of claim 1, further comprising:
retrieving updated network latency data relating to the selected cloud service provider;
determining, based on the updated network latency data relating to the selected cloud service provider, that the network latency at the selected cloud service provider exceeds a threshold;
receiving updated network latency data relating to the remaining cloud service providers in the plurality;
selecting, based on the network latency data relating to the remaining cloud service providers in the plurality, an alternative cloud service provider from the plurality;
retrieving data relating to the state of the virtual desktop at the first cloud service provider;
sending, to the alternative cloud service provider, a request to provision the VM, the request including the data relating to the state of the virtual desktop at the first cloud service provider; and
sending, to the client device, instructions for accessing the virtual desktop at the alternative cloud service provider.

7. The method of claim 1, wherein the network latency data for each of the cloud service providers is received from an agent executing on a pre-provisioned VM running at the corresponding cloud service provider.

8. A non-transitory, computer-readable medium containing instructions that, when executed by a hardware-based processor, causes the processor to perform stages for provisioning a desktop interface at a cloud service provider, the stages comprising:
receiving a request for access to a desktop interface at a client device;
retrieving network latency data related to a plurality of cloud service providers;
selecting, based on the network latency data, a cloud service provider from the plurality for provisioning a virtual machine (“VM”) that hosts the desktop interface;
sending, to the selected cloud service provider, a request to provision the VM; and
sending, to the client device, instructions for accessing the VM.

9. The non-transitory, computer-readable medium of claim 8, wherein retrieving the network latency data is performed by a plurality of VMs, each of the plurality of VMs executing at one of the plurality of cloud service providers, respectively, wherein each of the plurality of VMs executes an agent that tests the network latency between the respective VM and the client device.

10. The non-transitory, computer-readable medium of claim 8, the stages further comprising receiving provisioning cost data for each of the plurality of cloud service providers, the provisioning cost data indicating a cost for provisioning the VM on the corresponding cloud service provider, wherein selecting the selected cloud service provider comprises:
assigning a network latency score to each of the plurality of cloud service providers;
applying a provisioning cost multiplier to the network latency score for each of the plurality of cloud service providers, the provisioning cost multiplier being based on the cost for provisioning the VM on the corresponding cloud service provider;
calculating, for each of the plurality of cloud service providers, a provisioning score, the provisioning score being based on the cloud service provider's network latency score and provisioning cost multiplier; and
selecting, based on the provisioning scores, the selected cloud service provider based on the selected cloud service provider having a lowest provisioning score.

11. The non-transitory, computer-readable medium of claim 10, wherein each cloud service provider with a network latency below a threshold is assigned a same network latency score.

12. The non-transitory, computer-readable medium of claim 10, the stages further comprising determining a geographic location of the client device, wherein the network latency data and provisioning cost data are based on the geographic location.

13. The non-transitory, computer-readable medium of claim 8, the stages further comprising:
retrieving updated network latency data relating to the selected cloud service provider;
determining, based on the updated network latency data relating to the selected cloud service provider, that the network latency at the selected cloud service provider exceeds a threshold;
receiving updated network latency data relating to the remaining cloud service providers in the plurality;
selecting, based on the network latency data relating to the remaining cloud service providers in the plurality, an alternative cloud service provider from the plurality;
retrieving data relating to the state of the virtual desktop at the first cloud service provider;
sending, to the alternative cloud service provider, a request to provision the VM, the request including the data relating to the state of the virtual desktop at the first cloud service provider; and
sending, to the client device, instructions for accessing the virtual desktop at the alternative cloud service provider.

14. The non-transitory, computer-readable medium of claim 8, wherein the network latency data for each of the cloud service providers is received from an agent executing on a pre-provisioned VM running at the corresponding cloud service provider.

15. A system for provisioning a desktop interface at a cloud service provider, comprising:
a memory storage including a non-transitory, computer-readable medium comprising instructions; and
a hardware-based processor that executes the instructions to carry out stages comprising:
receiving a request for access to a desktop interface at a client device;
retrieving network latency data related to a plurality of cloud service providers;
selecting, based on the network latency data, a cloud service provider from the plurality for provisioning a virtual machine (“VM”) that hosts the desktop interface;
sending, to the selected cloud service provider, a request to provision the VM; and
sending, to the client device, instructions for accessing the VM.

16. The system of claim 15, wherein retrieving the network latency data is performed by a plurality of VMs, each of the plurality of VMs executing at one of the plurality of cloud service providers, respectively, wherein each of the plurality of VMs executes an agent that tests the network latency between the respective VM and the client device.

17. The system of claim 15, the stages further comprising receiving provisioning cost data for each of the plurality of cloud service providers, the provisioning cost data indicating a cost for provisioning the VM on the corresponding cloud service provider, wherein selecting the selected cloud service provider comprises:
assigning a network latency score to each of the plurality of cloud service providers;
applying a provisioning cost multiplier to the network latency score for each of the plurality of cloud service providers, the provisioning cost multiplier being based on the cost for provisioning the VM on the corresponding cloud service provider;
calculating, for each of the plurality of cloud service providers, a provisioning score, the provisioning score being based on the cloud service provider's network latency score and provisioning cost multiplier; and
selecting, based on the provisioning scores, the selected cloud service provider based on the selected cloud service provider having a lowest provisioning score.

18. The system of claim 17, wherein each cloud service provider with a network latency below a threshold is assigned a same network latency score.

19. The system of claim 17, the stages further comprising determining a geographic location of the client device, wherein the network latency data and provisioning cost data are based on the geographic location.

20. The system of claim 15, the stages further comprising:
retrieving updated network latency data relating to the selected cloud service provider;
determining, based on the updated network latency data relating to the selected cloud service provider, that the network latency at the selected cloud service provider exceeds a threshold;
receiving updated network latency data relating to the remaining cloud service providers in the plurality;
selecting, based on the network latency data relating to the remaining cloud service providers in the plurality, an alternative cloud service provider from the plurality;
retrieving data relating to the state of the virtual desktop at the first cloud service provider;
sending, to the alternative cloud service provider, a request to provision the VM, the request including the data relating to the state of the virtual desktop at the first cloud service provider; and
sending, to the client device, instructions for accessing the virtual desktop at the alternative cloud service provider.
